(19) United States
(12) Patent Application Publication
(10) Pub. No.: US 2026/0048509 A1
(43) Pub. Date: Feb. 19, 2026

(54) SYSTEMS AND METHODS FOR ROBOT LEARNING AND CONTROLLING A ROBOT

(71) Applicant: COLLABORATIVE ROBOTICS, Santa Clara, CA (US)

(72) Inventors: Brandon Porter, Santa Clara, CA (US); Michael Lammers, Santa Clara, CA (US); Justin Koch, Santa Clara, CA (US); Michael Vogelsong, Santa Clara, CA (US)

(21) Appl. No.: 19/303,221

(22) Filed: Aug. 18, 2025

Related U.S. Application Data
(60) Provisional application No. 63/684,754, filed on Aug. 19, 2024.

(51) Int. Cl. B25J 9/16

(52) U.S. Cl. CPC B25J 9/1682; B25J 9/1661; B25J 9/1697

(57) ABSTRACT

A method may include receiving input data identifying an operation to be completed in an environment. The method may also include identifying, using an artificial intelligence (AI) model, a series of tasks to be performed by robots to complete the operation based on the input data. In addition, the method may include identifying a subset of the robots to perform the series of tasks based on capabilities to be used to perform the series of tasks. Further, the method may include causing the subset of the robots to autonomously perform the series of tasks to complete the operation.

### CROSS-REFERENCE TO RELATED APPLICATION

This patent application claims the benefit of and priority to U.S. Provisional App. No. 63/684,754 filed Aug. 19, 2024, titled “METHODS FOR ROBOT LEARNING,” which is incorporated in the present disclosure by reference in its entirety.

### FIELD

The embodiments discussed in the present disclosure are related to systems and methods for robot learning and controlling a robot.

### BACKGROUND

Unless otherwise indicated in the present disclosure, the materials described in the present disclosure are not prior art to the claims in the present application and are not admitted to be prior art by inclusion in this section.

Robots have been used in recent years to perform tasks in various manufacturing, warehouses, logistics, and delivery settings. Robotics has been useful in making repetitive tasks more efficient, thereby improving efficiency and lowering costs.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments of the present disclosure may include a method. The method may include receiving input data identifying an operation to be completed in an environment. The method may also include identifying, using an artificial intelligence (AI) model, a series of tasks to be performed by robots to complete the operation based on the input data. In addition, the method may include identifying a subset of the robots to perform the series of tasks based on capabilities to be used to perform the series of tasks. Further, the method may include causing the subset of the robots to autonomously perform the series of tasks to complete the operation.

One or more embodiments of the present disclosure may include a system. The system may include one or more computer readable media configured to store instructions. The system may also include a processor coupled to the computer readable media. The processor may be configured to execute the instructions to cause or direct the system to perform operations. The operations may include receiving input data identifying an operation to be completed in an environment. The operations may also include identifying, using an AI model, a series of tasks to be performed by robots to complete the operation based on the input data. In addition, the operations may include identifying a subset of the robots to perform the series of tasks based on capabilities to be used to perform the series of tasks. Further, the operations may include causing the subset of the robots to autonomously perform the series of tasks to complete the operation.

One or more embodiments of the present disclosure may include a device. The device may include one or more computer readable media configured to store instructions. The device may also include a processor coupled to the computer readable media. The processor may be configured to execute the instructions to cause or direct the device to perform operations. The operations may include obtaining input data indicating an event that occurred in an environment. The operations may also include identifying, using an AI model, a series of tasks to be performed by a robot based on the event or the environment. In addition, the operations may include identifying, using the AI model, a set of capabilities to be used to perform the series of tasks by the robot. The set of capabilities may be based on the series of tasks. Further, the operations may include determining a set of capabilities for each robot of a plurality of robots. Each set of capabilities may indicate operations, tasks, or functions that the corresponding robot is able to perform. The operations may include selecting one or more particular robots from the plurality of robots to perform the series of tasks based on the set of capabilities of the one or more particular robots including at least a percentage of the set of capabilities to be used to perform the series of tasks. In addition, the operations may include causing the one or more particular robots to autonomously perform the series of tasks.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates a block diagram of an example operational environment in which a selected autonomous robot or autonomous robots may operate;

FIG. 2 illustrates an example operational environment in which the selected robot and the robots of FIG. 1 may operate;

FIG. 3 illustrates a flowchart of an example method to identify a subset of robots to perform a series of tasks and cause the subset of robots to autonomously perform the series of tasks to complete an operation, and

FIG. 4 illustrates an example computing system that may be used to identify a subset of robots to perform a series of tasks and cause the subset of robots to autonomously perform the series of tasks to complete an operation,

all according to at least one embodiment described in the present disclosure.

### DETAILED DESCRIPTION

Robots may be configured to perform various tasks to complete an operation. The robots may receive instructions or input data that specify the operation that is to be completed. In some robot systems, the robots may operate as isolated units with limited ability to share information or coordinate tasks with each other. In other robot systems, the robots may communicate to transfer data and basic information regarding statuses of the robots. For example, the robots may communicate a current task, a location, coordinates, battery levels, or identification information of the robots.

These robot systems may implement rigid, set, or pre-determined communication protocols. The communication protocols may prevent dynamic or context aware communication or coordination between the robots. For example, the communication protocols may include structured application programming interfaces (APIs), pre-defined command sets, or both, which are inflexible or prevent adaptation for dynamic tasks. Accordingly, communication between the robots using such communication protocols may be limited to basic information.

Some embodiments described in the present disclosure may permit a selected robot or a centralized device to communicate with the robots using a natural language format. The selected robot or the centralized device may implement an AI model to identify tasks to be used to complete the operation. In addition, the selected robot or the centralized device may implement the AI model to generate commands in the natural language format to facilitate collaborative execution of the tasks by the robots. The natural language format may be flexible and allow more complex information to be transmitted compared to the rigid communication protocols. For example, the natural language format may allow the robots to coordinate performing various tasks to complete dynamic or complex operations. The selected robot or the centralized device may identify tasks to be performed by the robots to complete the operation. In addition, the selected robot or the centralized device may communicate with the robots using the natural language format to request assistance, coordinate, or both to perform the tasks to complete the operation. Accordingly, the robots can assist each other to perform the tasks and complete of the operation.

According to at least one embodiment described in the present disclosure, the selected robot or the centralized device may receive or otherwise obtain input data. The input data may identify an operation to be completed in an environment. The selected robot or the centralized device may also identify, using the AI model, a series of tasks to be performed by the robots to complete the operation based on the input data. In addition, the selected robot or the centralized device may identify a subset of the robots to perform the series of tasks based on capabilities to be used to perform the series of tasks. Further, the selected robot or the centralized device may cause the subset of the robots to autonomously perform the series of tasks to complete the operation.

As described briefly above and in more detail below, the selected robot or the centralized device may generate the commands in the natural language format to provide flexible communication. Generating the commands in the natural language format may permit the selected robot or the centralized device to coordinate performance of the tasks in a manner that is dynamic, context-aware, or both. Additionally, generating the commands in the natural language format may provide flexibility in how the commands are formatted and processed. The flexibility in how the commands are formatted may reduce an amount of time or power to generate or process the commands compared to the rigid communication protocols. Further, the selected robot or the centralized device may identify capabilities of or request assistance from the robots to perform complex or dynamic tasks that have not been pre-programmed into the robots.

In addition, the natural language format may permit a human operator to review the commands, assignments of tasks, or both. Further, the natural language format may allow the human operator to debug the commands to identify why an operation was not properly completed, provide updated input data, or both.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

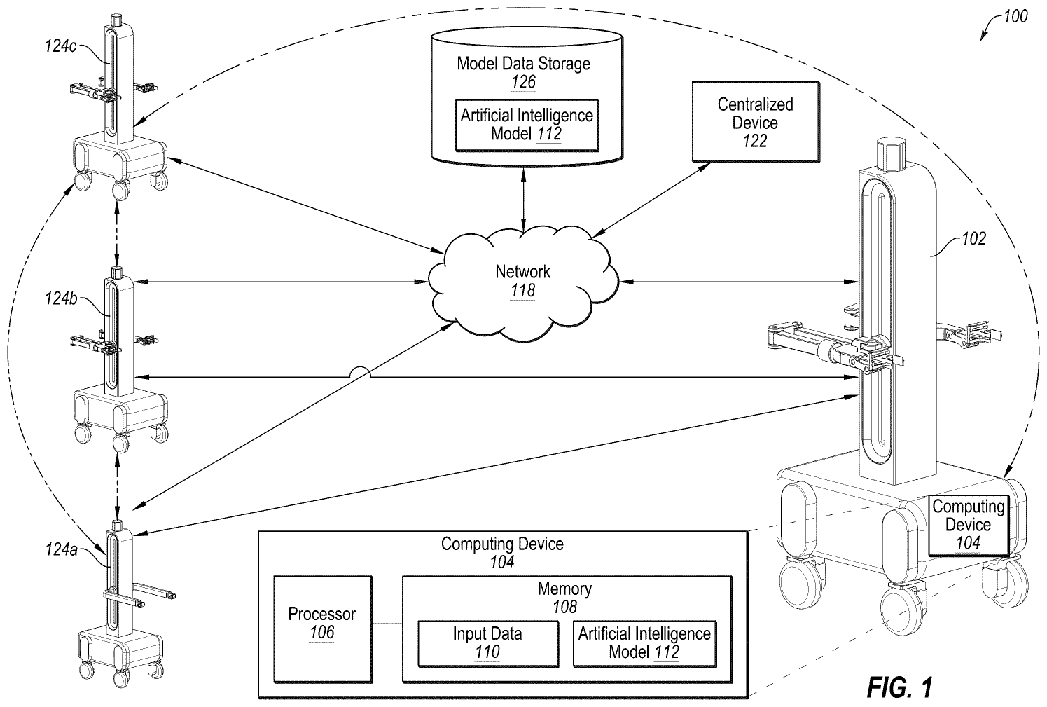

FIG. 1 illustrates a block diagram of an example operational environment 100 in which a selected autonomous robot 102 (referred to in the present disclosure as the selected robot 102) or autonomous robots 124a-c (referred to in the present disclosure as the robots 124a-c) may operate, in accordance with at least one embodiment described in the present disclosure. The environment 100 may include any location in which the robots 102, 124a-c may operate. For example, the environment 100 may include a warehouse, a hospital, a campus, a building, a field, a construction site, and the like.

The robots 102, 124a-c may directly communicate with each other. For example, the robots 102, 124a-c may send each other messages without using a network 118. Additionally or alternatively, the robots 102, 124a-c may communicate with each other via the network 118. For example, the network 118 may include a local network that communicatively couples the robots 102, 124a-c.

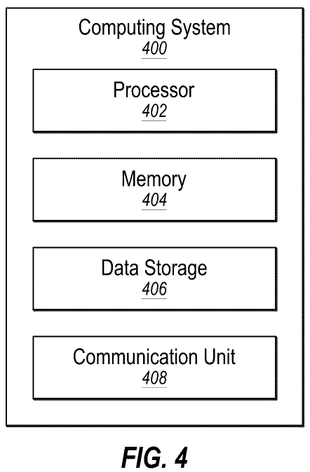

The selected robot 102 may include a computing device 104, which may include a desktop computer, a laptop computer, a smartphone, a mobile phone, a tablet computer, a server, a processing system, or any other computing system or set of computing systems that may be used for performing the operations described in this disclosure. An example of such a computing system is described below with reference to FIG. 4. The computing device 104 may include a processor 106 and a memory 108.

The processor 106 may include a central processing unit (CPU), a microprocessor (μP), a microcontroller (μC), a digital signal processor (DSP), a field-programmable gate array (FPGA), an application-specific integrated circuit (ASIC), or any combination thereof. The processor 106 may be configured to execute computer instructions that, when executed, cause the processor 106 or the computing device 104, to perform or control performance of one or more of the operations described herein with respect to operation of the robot 102. The processor 106 may be implemented using a combination of hardware and software. In the present disclosure, operations described as being performed by the processor 106 or the computing device 104 may include operations that the processor 106 or the computing device 104 directs a corresponding system to perform.

The memory 108 may include a storage medium such as a RAM, persistent or non-volatile storage such as ROM, EEPROM, CD-ROM, or other optical disk storage, magnetic disk storage or other magnetic storage device, NAND flash memory or other solid state storage device, or other persistent or non-volatile computer storage medium. The memory 108 may store computer instructions that may be executed by the processor 106 or the computing device 104 to perform or control performance of one or more of the operations described herein with respect to operation of the selected robot 102. In addition, the memory 108 may store an AI model 112 persistently and/or at least temporarily. Further, the memory 108 may store input data 110 persistently and/or at least temporarily.

The environment 100 may include a model data storage 126 that includes any memory or data storage. The model data storage 126 may include network communication capabilities such that other components in the environment 100 may communicate with the model data storage 126. For example, the computing device 104 may obtain the AI model 112 or any other appropriate data from the model data storage 126. In some embodiments, the model data storage 126 may include computer-readable storage media for carrying or having computer-executable instructions or data structures stored thereon. The computer-readable storage media may include any available media that may be accessed by a general-purpose or special-purpose computer, such as a processor. For example, the model data storage 126 may include computer-readable storage media that may be tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may be included in the model data storage 126.

The network 118 may include any communication network configured for communication of signals between any of the components (e.g., 102, 122, 124a-c, or 126) of the environment 100. The network 118 may be wired or wireless. The network 118 may have numerous configurations including a star configuration, a token ring configuration, or another suitable configuration. Furthermore, the network 118 may include a local area network (LAN), a wide area network (WAN) (e.g., the Internet), and/or other interconnected data paths across which multiple devices may communicate. In some embodiments, the network 118 may include a peer-to-peer network. The network 118 may also be coupled to or include portions of a telecommunications network that may enable communication of data in a variety of different communication protocols.

In some embodiments, the network 118 includes or is configured to include a BLUETOOTH® communication network, a Z-Wave® communication network, an Instcon® communication network, an EnOccan® communication network, a wireless fidelity (Wi-Fi) communication network, a ZigBee communication network, a HomePlug communication network, a Power-line Communication (PLC) communication network, a message queue telemetry transport (MQTT) communication network, a MQTT-sensor (MQTT-S) communication network, a constrained application protocol (CoAP) communication network, a representative state transfer application protocol interface (REST API) communication network, an extensible messaging and presence protocol (XMPP) communication network, a cellular communications network, a thread communication network, a matter communication network, any similar communication networks, or any combination thereof for sending and receiving data. The data communicated in the network 118 may include data communicated via short messaging service (SMS), multimedia messaging service (MMS), hypertext transfer protocol (HTTP), direct data connection, wireless application protocol (WAP), e-mail, smart energy profile (SEP), ECHONET Lite, OpenADR, or any other protocol that may be implemented with the components (e.g., 102, 122, 124a-c, or 126) of the environment 100.

The robots 102, 124a-c may communicate with each other using a natural language format. Additionally or alternatively, a centralized device 122 may communicate with the robots 102, 124a-c using the natural language format. The natural language format may include messages, commands, or other forms of communication that utilize human-readable text and speech patterns. In addition, the natural language format may permit the centralized device 122, the selected robot 102, or the robots 124a-c to communicate using in a manner that resembles human conversation.

The selected robot 102 may operate as a primary coordinator or orchestrator of tasks to be performed to complete an operation. The selected robot 102 may operate as the primary coordinator because it initially received the input data 110. Additionally or alternatively, the selected robot 102 may operate as the primary coordinator because it received instructions from the centralized device 122 or the human operator. Aspects described as being performed by the computing device 104 may be performed by the centralized device 122 and vice versa. For case of discussion, the following discussion describes the computing device 104 as performing the various aspects. However, these aspects may be performed by the centralized device 122 in addition to or instead of the computing device 104.

The robots 102, 124a-c may include effectors that allow the robots 102, 124a-c to interact with objects (not shown) within the environment 100. The effectors of the robots 102, 124a-c may be the same. Alternatively, at least a portion of the effectors of the robots 102, 124a-c may be different. For example, as shown in FIG. 1, the effectors of the selected robot 102 and the robots 124b-c include grasping effectors that are configured to pinch or squeeze the object. As another example, as shown in FIG. 1, the effectors of the robot 124a include hooked effectors that are configured to receive a portion of the object in an opening (e.g., hook the portion of the object).

The computing device 104 may obtain the AI model 112 from the model data storage 126 via the network 118. Alternatively, the computing device 104 may generate the AI model 112 locally. Examples of the AI model 112 include, but are not limited to a large language model, a logic model, a rule-based model (e.g., if-then rules), a decision tree model, a convolutional neural network model, a linear regression model, a logistic regression model, a supervised learning model, an unsupervised learning model, a deep learning model, a vision language model, a machine learning model, any other appropriate AI model, or some combination thereof.

The AI model 112 may be configured to identify the environment 100, events occurring in the environment 100, or both. For example, the AI model 112 may be trained to identify a type of the environment 100 or a type of event that is occurring in the environment 100. Example events may include an object being placed in the environment 100, a human operator action, a spill, an accident, a code (e.g., code blue), or any other appropriate event. Additionally, the AI model 112 may be configured to identify objects such as the selected robot 102, the robots 124a-c, boxes, carts, cargo, humans, or any other appropriate object within the environment 100.

The input data 110 may include information that identifies an operation to be completed in the environment 100. For example, the input data 110 may identify operational parameters that define a nature or a scope of the operation. Additionally, the input data 110 may include information that identifies details of the operation. For example, the input data 110 may identify timing details of when the operation should start or be completed or sequencing details of the operation. Further, the input data 110 may include operator details that indicate how the operation should be performed or details the should be considered when completing the operation. For example, the operator details may indicate preferred methods, quality standards, a series of actions that will be taken by the human operator, or stylistic choices that should be considered when completing the operation.

Additionally or alternatively, the input data 110 may identify the environment 100 or environmental context information. For example, the input data 110 may describe physical aspects of the environment 100, objects within the environment 100, or conditions (e.g., wet, dry, cold, warm, surface types, or lighting conditions) of portions of the environment 100.

The input data 110 may identify an event that has occurred, is occurring, or is to occur. For example, the input data 110 may include input from the human operator identifying that an object has been, is being, or will be placed in the environment. As another example, the input data 110 may identify that a decision to move an object to another location has been made. As yet another example, the input data 110 may identify an operator action, a spill, an accident, a code (e.g., code blue), or any other appropriate event has occurred.

The input data 110 may include information about or from the robots 102, 124a-c. For example, the input data 110 may identify the robots 102, 124a-c, capabilities of the robots 102, 124a-c, sensor data from the robots 124a-c, or any other appropriate information. The sensor data may include visual data, proximity measurements, environmental conditions, or status information obtained by sensors (not shown) of the robots 102, 124a-c.

The computing device 104 may execute the AI model 112 to identify a series of tasks to be performed by at least some of the robots 102, 124a-c to complete the operation. The AI model 112 may identify the series of tasks based on the input data 110. In particular, the AI model 112 may identify the series of tasks based on the environment 100, the environmental conditions, the event, the information about or from the robots 102, 124a-c, the operational details, or any other information in the input data 110. In some embodiments, the AI model 112 may include a single model that is configured to process the input data 110. In other embodiments, the AI model 112 may include multiple sub-models that are configured to process different portions of the input data 110. For example, the AI model 112 may include a large language model configured to process language portions of the input data 110, a vision model configured to process images or videos in the input data, or any other appropriate or combination of models to process the input data 110.

The computing device 104 may execute the AI model 112 to identify capabilities to be used to perform the series of tasks. The AI model 112 may identify the capabilities to be used to perform the series of tasks based on the input data 110, the series of tasks, or both. For example, the AI model 112 may identify the event, the environment, or any other appropriate information based on the input data 110. In addition, the AI model 112 may identify the capabilities based on the event, the environment, or other information. The set of capabilities may include or indicate specific functions, skills, operations, tasks, or attributes that could be used to perform the series of tasks. For example, the set of capabilities may include functions, skills, or attributes that are to be used by the robots 102, 124a-c to perform the series of tasks. Example operational functions may include end effector functions (e.g., gripper types or load capacity parameters), mobility or precision functions, navigation functions, obstacle avoidance functions, movement coordination functions, visual recognition functions, sensing functions, or communication functions.

The computing device 104 may determine capabilities for the robots 102, 124a-c. For example, the computing device 104 may determine a first set of capabilities for the selected robot 102, a second set of capabilities for the robot 124a, a third set of capabilities for the robot 124b, or a fourth set of capabilities for the robot 124c. The sets of capabilities may indicate operations, tasks, or functions that the robots 102, 124a-c are able to perform.

To determine the capabilities of the robots 124a-c, the computing device 104 may query the robots 124a-c. For example, the computing device 104 may transmit a capability request message to the robots 124a-c. Additionally or alternatively, the computing device 104 may query the centralized device 122 for the capabilities of the robots 124a-c. The computing device 104 may receive capability messages from one or more of the robots 124a-c, the centralized device 122, or some combination thereof.

The capability messages may identify the capabilities of the robots 124a-c. The capability messages may be in the natural language format. The computing device 104 may determine the capabilities of the robots 124a-c based on the capability messages. For example, the computing device 104 may perform language processing on the capability messages to identify the capabilities of the robots 124a-c. The capability messages may identify current locations of the robots 124a-c, current availabilities of the robots 124a-c, or current effectors or parts of the robots 124a-c.

Additionally or alternatively, the input data 110 may include a description of the capabilities of the robots 124a-c (e.g., a static specification). For example, the description may indicate that the robot 124b can handle objects up to fifty pounds or that the robot 124c can manipulate objects that are positioned up to thirty six inches off the ground surface.

The computing device 104 may execute the AI model 112 to identify a subset or all the robots 102, 124a-c to perform the series of tasks. For example, the AI model 112 may identify the robot 124b or both robots 124a-b to perform the series of tasks. As another example, the AI model 112 may identify the selected robot 102 and the robot 124c to perform the series of tasks. As yet another example, the AI model 112 may identify the selected robot 102 and all the robots 124a-c to perform the series of tasks. The AI model 112 may identify the subset of the robots 102, 124a-c to perform the series of tasks based on one or more parameters. For example, the AI model 112 may identify the subset of the robots 102, 124a-c based on a fewest number of robots that match all or a portion of the capabilities to be used to perform the series of tasks. As another example, the AI model 112 may identify the subset of the robots 102, 124a-c based on which of the robots 102, 124a-c are closest in proximity to the locations at which tasks are to be performed.

The AI model 112 may identify the subset of the robots 102, 124a-c based on the capabilities of the robots 102, 124a-c and the identified capabilities to perform the series of tasks. The AI model 112 may analyze the capabilities of the robots 102, 124a-c and the selected robot 102 to determine which of them are capable of performing the series of tasks.

The AI model 112 may identify the subset of the robots 102, 124a-c to perform the series of tasks based on the capabilities of at least a portion of the robots 102, 124a-c including a threshold percentage (e.g., a particular percentage) or more of the capabilities to be used to perform the series of tasks. For example, the capabilities to be used to perform the series of tasks may include five capabilities and the AI model 112 may identify the subset of the robots 102, 124a-c to be able to perform at least three of the five capabilities (e.g., sixty percent). As another example, the capabilities to be used to perform the series of tasks may include seven capabilities and the AI model 112 may identify the subset of the robots 102, 124a-c to be able to perform all seven of the capabilities (e.g., one hundred percent).

The computing device 104 may execute the AI model 112 to match the capabilities of the subset of the robots 102, 124a-c to the capabilities to be used to perform the series of tasks. For example, the AI model 112 may match capabilities of the end effectors of the selected robot 102 or the robots 124a-c to match capabilities to manipulate an object. The AI model 112 may evaluate the capabilities of the robots 102, 124a-c in relation to the environment 100, the environmental conditions, or both. For example, the AI model 112 may evaluate the capabilities of the robots 102, 124a-c to identify which of them can navigate the environment 100, operate in the environmental conditions, or any other appropriate environmental factor.

The AI model 112 may also identify the subset of the robots 102, 124a-c based on the operational details. For example, the AI model 112 may determine proximity of the selected robot 102 and the robots 124a-c to locations where the series of tasks are to be performed. In addition, the AI model 112 may identify the subset of the robots 124a-c to include ones that are closest to the locations to minimize or reduce an amount of time spent performing the series of tasks.

The AI model 112 may execute the AI model 112 to generate tasks assignment for the subset of the robots 102, 124a-c. The tasks assignments may identify a portion of the series of tasks that the subset of the robots 102, 124a-c are to perform. Additionally, the computing device 104 may execute the AI model 112 to generate commands for the subset of the robots 102, 124a-c. The commands may identify the tasks assignments. The commands may be in the natural language format.

The computing device 104 may send the commands to the subset of the robots 102, 124a-c. The subset of the robot 102, 124a-c may perform the tasks identified in a corresponding command. Accordingly, the computing device 104 may coordinate movement and manipulation actions by the subset of the robots 102, 124a-c. Therefore, the computing device 104 may cause the subset of the robots 102, 124a-c to autonomously perform the series of tasks in the environment 100.

The computing device 104 may update the capabilities of the robots 102, 124a-c based on whether the robots 102, 124a-c successfully perform the series of tasks. The computing device 104 may obtain feedback data indicating if the subset of the robots 102, 124a-c successfully perform the series of tasks. If the series of tasks are not successfully performed due to issues with the robots 102, 124a-c, the computing device 104 may update the capabilities of the robots 102, 124a-c indicated in the input data 110 accordingly. For example, if the series of tasks was not successfully performed because an end effector of the robot 124b failed or is broken, the computing device 104 may record this information in the input data 110. Therefore, the AI model 112 may not assign subsequent tasks to the robots 102, 124a-c that cannot be performed by the robots 102, 124a-c due the issues with the robots 102, 124a-c.

Modifications, additions, or omissions may be made to the environment 100 of FIG. 1 without departing from the scope of the present disclosure. The computing device 104 is illustrated and discussed as being located on the selected robot 102 for example purposes. In some embodiments, the computing device 104 may be located remote to the selected robot 102 and may form part of any appropriate network. For example, the computing device 104 may be located in a building positioned in or proximate to the selected robot 102, the centralized device 122, or any other appropriate computing system. In other embodiments, the computing device 104 may include a cloud computing device that is accessed via the Internet or any other appropriate communication network. In some embodiments, the centralized device 122 may include a monitoring system configured to monitor the environment 100.

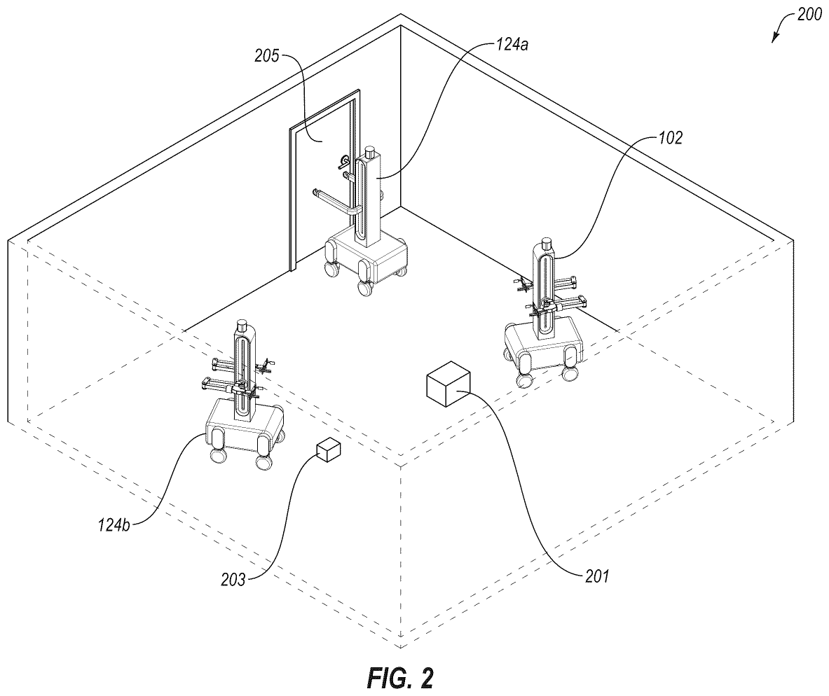

FIG. 2 illustrates an example an example operational environment 200 in which the selected robot 102 and the robots 124a-b of FIG. 1 may operate, in accordance with at least one embodiment described in the present disclosure. The environment 200 includes a room that includes the robots 102, 124a-b and multiple objects 201, 203. The selected robot 102 may perform operations described in the present disclosure to perform an operation including “remove the objects from the room.”

The computing device 104 may receive the input data 110 (not shown in FIG. 2). The input data 110 may identify the event that has occurred (e.g., the objects 201, 203 have been placed in the environment 200). Additionally or alternatively, the input data 110 may identify the event that is to occur or the operation. For example, the operation may be “remove the objects from the room.” The input data 110 may also include information about the robots 102, 124a-b, the environment 200, or both. For example, the input data 110 may indicate that the robots 102, 124b include the same grasping effectors and that the robot 124a includes the hooked effectors. As another example, the input data 110 may indicate that the environment 200 includes a door 205 with a cylindrical handle that leads out from the environment 200. As yet another example, the input data 110 may identify specific dimensions or details of the objects 201, 203 (e.g., height, width, length, weight, material, or type of the objects 201, 203).

The computing device 104 may execute the AI model 112 (not shown in FIG. 2) to identify the series of tasks be performed to remove the objects 201, 203 from the room. The AI model 112 may identify the series of tasks to be performed based on the input data 110. For example, the AI model 112 may identify the series of tasks as navigate proximate to the objects 201, 203, manipulate the objects 201, 203, navigate proximate to the door 205, open the door 205, navigate through the door 205.

The computing device 104 may execute the AI model 112 to identify capabilities to be used to perform the series of tasks to remove the objects 201, 203 from the room. The AI model 112 may identify the capabilities to be used to perform the series of tasks based on the input data 110, the series of tasks, or both. For example, the AI model 112 may identify the capabilities to be used to perform the series of tasks as an ability to navigate, an ability to manipulate the box shaped objects 201, 203, an ability to manipulate the objects 201, 203 when on the floor, an ability to manipulate a cylinder handle, an ability to navigate while interacting with the cylinder handle, and an ability to navigate while carrying the objects 201, 203.

The computing device 104 may determine the capabilities for the robots 102, 124a-b based on the capability messages or a query of the centralized device 122 (not shown in FIG. 2) as discussed above. For example, the computing device 104 may determine the first set of capabilities of the selected robot 102 and the second set of capabilities of the robot 124b as including an ability to navigate, an ability manipulate the box shaped objects 201, 203, an ability to manipulate the objects 201, 203 when on the floor, and an ability to navigate while carrying the objects 201, 203. As another example, the computing device 104 may determine the third set of capabilities of the robot 124a as including an ability to navigate, an ability to manipulate the cylinder handle, and an ability to navigate while interacting with the cylinder handle.

The computing device 104 may determine that the robots 102, 124a-b are capable of navigating because the robots 102, 124a-b include wheels. In addition, the computing device 104 may determine that the robots 102, 124b are capable of manipulating the objects 201, 203 and navigating while carrying the objects 201, 203 because the robots 102, 124b include the grasping effectors and the wheels. Further, the computing device 104 may determine that the robots 102, 124b are capable of manipulating the objects 201, 203 when on the floor because the robot 102, 124b include arms that can extend and reach the objects 201, 203 when on the floor. The computing device 104 may determine that the robot 124a is capable of manipulating the cylinder handle and navigating while interacting with the cylinder handle because the robot 124a includes the hooked effectors, a spine that can raise and lower the hooked effectors, and the wheels.

The computing device 104 may identify all the robots 102, 124a-b to perform the series of tasks. For example, the computing device 104 may identify all the robots 102, 124a-b to perform the series of tasks based on the capabilities of the robots 102, 124a-c including all the capabilities to be used to perform the series of tasks.

The computing device 104 may execute the AI model 112 to generate tasks assignment for the robots 102, 124a-b that identify task to be performed by the robots 102, 124a-b. For example, the AI model 112 may generate a first task assignment identifying that the selected robot 102 is to navigate proximate to the object 201, manipulate the object 201 to pick it up, navigate proximate to the door 205 while carrying the object 201, wait for the door 205 to be opened, and navigate through the door 205 when opened while carrying the object 201. As another example, the AI model 112 may generate a second task assignment identifying that the robot 124b is to navigate proximate to the object 203, manipulate the object 203 to pick it up, navigate proximate to the door 205 while carrying the object 203, wait for the door 205 to be opened, and navigate through the door 205 when opened while carrying the object 203. As yet another example, the AI model 112 may generate a third task assignment identifying that the robot 124a is to navigate proximate to the door 205, manipulate the cylinder handle to release the door 205 by raising the hooked effectors, navigate while interacting with the cylinder handle to open the door 205 and keep the door 205 open.

The computing device 104 may execute the AI model 112 to generate commands for the robots 102, 124a-b. The commands may identify the tasks assignments for the corresponding robot 102, 124a-b. The commands may be in the natural language format. For example, a first command may identify the first task assignment, a second command may identify the second task assignment, and a third command may identify the third task assignment.

The computing device 104 may send the commands to the robots 124a-b to cause the robots 102, 124a-b to perform corresponding tasks. For example, the computing device 104 send the first command to the selected robot 102 to cause the selected robot 102 to perform the first task assignment, the second command to the robot 124b to cause the robot 124b to perform the second task assignment, and the third command to the robot 124a to cause the robot 124a to perform the third task assignment. Accordingly, the computing device 104 may coordinate operation of the robots 102, 124a-b to perform the series of tasks and complete the operation. Accordingly, the computing device may cause the robot 102, 124a-b to autonomously perform the series of tasks to complete the operation of “remove the objects from the room.”

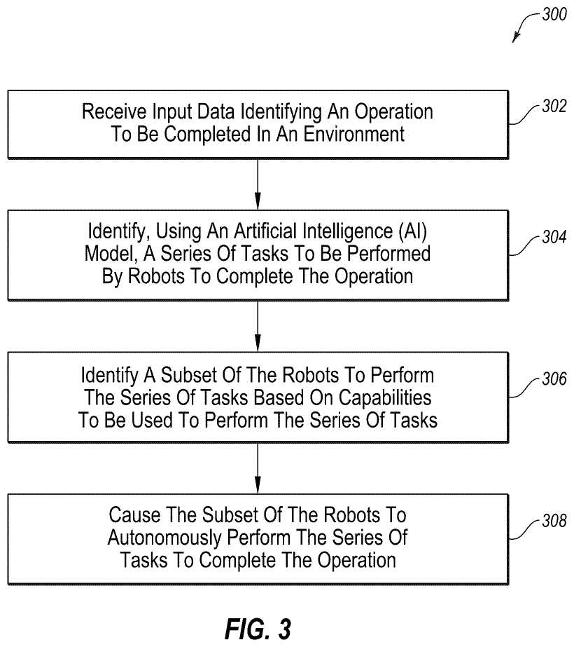

FIG. 3 illustrates a flowchart of an example method 300 to identify a subset of robots to perform a series of tasks and cause the subset of robots to autonomously perform the series of tasks to complete an operation, in accordance with at least one embodiment described in the present disclosure. The method 300 may be performed by any suitable system, apparatus, or device with respect to identifying the set of tasks to be performed by the robot. For example, the computing device 104 of or the centralized device 122 FIG. 1 may perform or direct performance of one or more of the operations associated with the method 300. The method 300 may include one or more blocks 302, 304, 306, or 308. Although illustrated with discrete blocks, the steps and operations associated with one or more of the blocks of the method 300 may be divided into additional blocks, combined into fewer blocks, or eliminated, depending on the particular implementation.

At block 302, input data may be received that identifies an operation to be completed in an environment. For example, the computing device 104 of FIG. 1 may receive the input data 110. The input data 110 may identify an operation to be completed by the selected robot 102 or the robots 124a-c in the environment. At block 304, a series of tasks to be performed by robots to complete the operation may be identified using an AI model. The series of tasks may be identified based on the input data. For example, the computing device 104 of FIG. 1 may execute the AI model 112 to identify the series of tasks to be performed by the robots 102, 124a-c to complete the operation. The AI model 112 may identify the series of tasks based on the input data 110.

At block 306, a subset of the robots may be identified to perform the series of tasks based on capabilities to be used to perform the series of tasks. For example, the computing device 104 of FIG. 1 may identify a subset of the robots 102, 124a-c to perform the series of tasks based on the capabilities of the robots 102, 124a-c and the capabilities to be used to perform the series of tasks.

At block 308, the subset of the robots may be caused to autonomously perform the series of tasks to complete the operation. For example, the computing device 104 of FIG. 1 may transmit commands to the subset of the robots 102, 124a-c to cause the subset of the robots 102, 124a-c to autonomously perform the series of tasks to complete the operation within the environment 100.

Modifications, additions, or omissions may be made to the method 300 without departing from the scope of the present disclosure. For example, the operations of method 300 may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the described embodiments.

FIG. 4 illustrates an example computing system 400 that may be used to identify a subset of robots to perform a series of tasks and cause the subset of robots to autonomously perform the series of tasks to complete an operation, in accordance with at least one embodiment of the present disclosure. The computing system 400 may be configured to implement or direct one or more operations associated with the computing device 104, the centralized device 122, or both. The computing system 400 may include a processor 402, memory 404, data storage 406, and a communication unit 408, which all may be communicatively coupled. In some embodiments, the computing system 400 may be part of any of the systems or devices described in this disclosure. For example, the computing system 400 may be configured to perform one or more of the tasks described above with respect to the computing device 104, the centralized device 122, or both.

The processor 402 may include any computing entity, or processing device including various computer hardware or software modules and may be configured to execute instructions stored on any applicable computer-readable storage media. For example, the processor 402 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 402 may include any number of processors distributed across any number of networks or physical locations that are configured to perform individually or collectively any number of operations described herein.

In some embodiments, the processor 402 may be configured to interpret and/or execute program instructions and/or process data stored in the memory 404, the data storage 406, or the memory 404 and the data storage 406. In some embodiments, the processor 402 may fetch program instructions from the data storage 406 and load the program instructions in the memory 404. After the program instructions are loaded into memory 404, the processor 402 may execute the program instructions.

For example, in some embodiments, the processor 402 may be configured to interpret and/or execute program instructions and/or process data stored in the memory 404, the data storage 406, or the memory 404 and the data storage 406. The program instruction and/or data may be related to an operator directed autonomous system such that the computing system 400 may perform or direct the performance of the operations associated therewith as directed by the instructions.

The memory 404 and the data storage 406 may include computer-readable storage media or one or more computer-readable storage mediums for carrying or having computer-executable instructions or data structures stored thereon. Such computer-readable storage media may be any available media that may be accessed by a computer, such as the processor 402.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a computer. Combinations of the above may also be included within the scope of computer-readable storage media.

Computer-executable instructions may include, for example, instructions and data configured to cause the processor 402 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 408 may include any component, device, system, or combination thereof that is configured to transmit or receive information over a network. In some embodiments, the communication unit 408 may communicate with other devices at other locations, the same location, or even other components within the same system. For example, the communication unit 408 may include a modem, a network card (wireless or wired), an infrared communication device, a wireless communication device (such as an antenna implementing 4G (LTE), 4.5G (LTE-A), and/or 5G (mmWave) telecommunications), and/or chipset (such as a Bluetooth® device (e.g., Bluetooth 5 (Bluetooth Low Energy)), an 802.6 device (e.g., Metropolitan Area Network (MAN)), a Wi-Fi device (e.g., IEEE 802.11ax, a WiMAX device, cellular communication facilities, etc.), and/or the like. The communication unit 408 may permit data to be exchanged with a network and/or any other devices or systems described in the present disclosure.

Modifications, additions, or omissions may be made to the computing system 400 without departing from the scope of the present disclosure. For example, in some embodiments, the computing system 400 may include any number of other components that may not be explicitly illustrated or described. Further, depending on certain implementations, the computing system 400 may not include one or more of the components illustrated and described.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
receiving input data identifying an operation to be completed in an environment;
identifying, using an artificial intelligence (AI) model, a series of tasks to be performed by robots to complete the operation based on the input data;
identifying a subset of the robots to perform the series of tasks based on capabilities to be used to perform the series of tasks; and
causing the subset of the robots to autonomously perform the series of tasks to complete the operation.

2. The method of claim 1 comprising:
identifying, using the AI model, the capabilities to be used to perform the series of tasks based on the input data; and
identifying capabilities for each of the robots, wherein the subset of the robots to perform the series of tasks is identified based on the capabilities to be used to perform the series of tasks and the capabilities for each of the robots.

3. The method of claim 2, wherein the subset of the robots to perform the series of tasks is identified based on the subset of the robots comprising a particular percentage or more of the capabilities to be used to perform the series of tasks.

4. The method of claim 2 comprising obtaining capability messages from the robots, wherein the capabilities for each of the robots are determined based on a corresponding capability message.

5. The method of claim 1, wherein the identifying the subset of the robots to perform the series of tasks comprises:
identifying, using the AI model, the capabilities to be used to perform the series of tasks;
identifying capabilities for each of the robots; and
matching the capabilities of the robots with the capabilities to be used to perform the series of tasks.

6. The method of claim 1, wherein the causing the subset of the robots to autonomously perform the series of tasks to complete the operation comprises generating commands for the subset of the robots in a natural language format, each of the commands identifying a portion of the series of tasks to be performed by a corresponding robot of the subset of the robots.

7. The method of claim 1, wherein:
the input data identifies the environment and an event that occurred in the environment; and
the AI model is configured to identify the capabilities to be used to perform the series of tasks based on the event and the environment.

8. A system comprising:
one or more computer readable media configured to store instructions; and
a processor coupled to the computer readable media, the processor configured to execute the instructions to cause or direct the system to perform operations, the operations comprising:
receiving input data identifying an operation to be completed in an environment;
identifying, using an artificial intelligence (AI) model, a series of tasks to be performed by robots to complete the operation based on the input data;
identifying a subset of the robots to perform the series of tasks based on capabilities to be used to perform the series of tasks; and
causing the subset of the robots to autonomously perform the series of tasks to complete the operation.

9. The system of claim 8, the operations comprising:
identifying, using the AI model, the capabilities to be used to perform the series of tasks based on the input data; and
identifying capabilities for each of the robots, wherein the subset of the robots to perform the series of tasks is identified based on the capabilities to be used to perform the series of tasks and the capabilities for each of the robots.

10. The system of claim 9, wherein the subset of the robots to perform the series of tasks is identified based on the subset of the robots comprising a particular percentage or more of the capabilities to be used to perform the series of tasks.

11. The system of claim 9, the operations comprising obtaining capability messages from the robots, wherein the capabilities for each of the robots are determined based on a corresponding capability message.

12. The system of claim 8, wherein the operation identifying the subset of the robots to perform the series of tasks comprises:
identifying, using the AI model, the capabilities to be used to perform the series of tasks;
identifying capabilities for each of the robots; and
matching the capabilities of the robots with the capabilities to be used to perform the series of tasks.

13. The system of claim 8, wherein the operation causing the subset of the robots to autonomously perform the series of tasks to complete the operation comprises generating commands for the subset of the robots in a natural language format, each of the commands identifying a portion of the series of tasks to be performed by a corresponding robot of the subset of the robots.

14. A device comprising:
one or more computer readable media configured to store instructions; and
a processor coupled to the computer readable media, the processor configured to execute the instructions to cause or direct the device to perform operations, the operations comprising:
obtaining input data indicating an event that occurred in an environment;
identifying, using an artificial intelligence (AI) model, a series of tasks to be performed by a robot based on the event or the environment;
identifying, using the AI model, a set of capabilities to be used to perform the series of tasks by the robot, the set of capabilities being based on the series of tasks;
determining a set of capabilities for each robot of a plurality of robots, each set of capabilities indicating operations, tasks, or functions that the corresponding robot is able to perform;
selecting one or more particular robots from the plurality of robots to perform the series of tasks based on the set of capabilities of the one or more particular robots including at least a percentage of the set of capabilities to be used to perform the series of tasks; and
causing the one or more particular robots to autonomously perform the series of tasks.

15. The device of claim 14, wherein the operations comprise identifying, using the AI model, the event and the environment, wherein the set of capabilities is further based on the event and the environment.

16. The device of claim 14, wherein the AI model comprises at least one of a large language model or a vision language model.

17. The device of claim 14, wherein the operations comprise obtaining a plurality of capability messages from the plurality of robots, wherein each of the sets of capabilities are determined based on the corresponding capability message.

18. The device of claim 17, wherein the plurality of capability messages are obtained in a natural language format.

19. The device of claim 14, wherein the plurality of robots are configured to communicate with each other using a natural language format.

20. The device of claim 14, wherein the device is located within at least one of:
a centralized device;
a robot of the plurality of robots;
a monitoring system; or
a computing device.
